(19) United States
(12) Patent Application Publication
(10) Pub. No.: US 2022/0051857 A1
(43) Pub. Date: Feb. 17, 2022

(54) SWITCHING TERMINAL

(71) Applicant: MITSUBISHI ELECTRIC POWER PRODUCTS, INC., Warrendale, PA (US)

(72) Inventors: James Losi, Allison Park, PA (US); Paul J. Vladuchick, Cranberry Township, PA (US)

(21) Appl. No.: 16/995,650

(22) Filed: Aug. 17, 2020

(51) Int. Cl. H01H 9/52; H01H 33/02; H01R 13/514; H01R 13/40; H01R 35/04; H01B 7/42

(52) U.S. Cl. CPC H01H 9/52; H01H 33/025; H01B 7/426; H01R 13/40; H01R 35/04; H01R 13/514

(57) ABSTRACT

Disclosed are example embodiments of a switching terminal that can be rotated with minimal parts. The switching terminal can include: an inner portion configured to be securely or loosely attached to an external conductor element; and an outer portion configured to be rotatably affixed to the inner portion when then inner portion is loosely attached to the external conductor and to be tightly affixed to the inner portion when then inner portion is tightly attached to the external conductor.

### FIELD

The disclosure relates generally to the field of switching apparatus, specifically and not by way of limitation, some embodiments are related to a high voltage switching apparatus.

### BACKGROUND

A switchgear assembly includes various components such as switching terminals, power supply rails (e.g., buses), fuses, circuit breakers, and other components used to isolate electrical equipment. Switchgear can be used to de-energize electrical components to allow work to be performed safely. One of the main components in a switchgear is a switching terminal.

Switching terminals are typically bolted to the current source or a circuit breaker and cannot be removed from the current source without unbolting the terminal to the current source. Certain switching terminals can be removed for replacement or maintenance. But typically, any changes in location of current contacts or terminal pads requires a new switching terminal that is configured with the appropriate size and configuration (e.g., location, angle) of the terminal pads.

Conventional switching arrangements include a selector switch for selecting and connecting the first busbar or the second busbar to the current source. A separate circuit breaker can be connected between the terminal and the power source. In conventional arrangements, in order to switch the load connection from one busbar to the other, an operator must first open the circuit breaker, use the selector switch to disconnect the currently connected busbar from the load connection and connect the other busbar to the load connection, and then close the circuit breaker.

It is desirable to provide an improved switching terminal for use in a switchgear and/or other electrical systems with less components and that is preferably more user friendly features.

### SUMMARY

Disclosed are example embodiments of a switching terminal. In one embodiment, the switching terminal includes: an inner portion configured to be securely or loosely attached to an external conductor element; and an outer portion configured to be rotatably affixed to the inner portion when then inner portion is loosely attached to the external conductor and to be tightly affixed to the inner portion when then inner portion is tightly attached to the external conductor. The outer portion of the switching terminal can include a plurality of fins.

The outer portion can have two or more fins. In some embodiments, outer portion can have three fins extending substantially perpendicular to the outer portion. The plurality of fins can include a plurality of holes, which can have a four-hole arrangement that is in compliance with the NEMA CC1 standard. The plurality of holes can have any number of holes and arrangement such that they are in compliance with the IEC or IEEE standard.

The outer portion can include a recess area having a lip configured to mate with a bottom surface of the inner portion.

The inner portion can include a rim configured to mate with the lip of the outer portion. This enables the inner portion to secure the outer portion and prevents it from moving in the axial direction once the inner portion is tightly attached to the external conductor. The inner portion also includes one or more holes to receive one or more bolts to attach the inner portion to the external conductor. The one or more holes of the inner portion can have a four-hole arrangement that is in compliance with the NEMA standard. Additionally, the one or more holes of the inner portion can have any number of holes and arrangement such that they are in compliance with the IEC or IEEE standard.

In some embodiments, the inner portion and the central receiving area can be circular. Inner and outer portions can be fabricated from a conductive metal such as, but not limited, to aluminum.

In another example embodiment, an apparatus with rotatable pads for voltage switching is disclosed. The apparatus includes: a center attachment portion configured to be selectively attached loosely or tightly to a conductive surface; and a peripheral portion having a recess to receive the center attachment portion. The peripheral portion is configured to be rotatably affixed to the center attachment portion when the center attachment portion is loosely attached to the conductive surface and to be tightly affixed to the attachment portion when the attachment portion is tightly attached to the conductive surface. The peripheral portion can include a plurality of protruding pads. Each of which can have a plurality of holes in arranged in a pattern corresponding to a pattern of the NEMA, IEC, or IEEE standard.

The recess of the apparatus can have a lip configured to engage and support the center attachment portion. The center portion can also include a lip configured to engage and support the peripheral portion.

The plurality of protruding pads can be three protruding pads extending substantially perpendicular to the center attachment portion, which can include one or more holes to receive one or more bolts to attach the center attachment portion to the external conductor. In some embodiments, one or more of the plurality of protruding pads are cooling pads. The plurality of protruding pads can also be a combination of cooling and conductive pads.

In another example embodiment, a voltage switching terminal is disclosed. The voltage switching terminal includes: an inner portion configured to be securely or loosely attached to an external conductor element; and an outer portion configured to be rotatably or securely affixed to the inner portion when then inner portion is loosely or securely attached to the external conductor, respectively. The outer portion of the switch terminal includes a plurality of fins. The outer portion includes a recess area having a lip configured to mate with a bottom surface of the inner portion.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates a switching terminal assembly in accordance with some embodiments of the present disclosure.

FIG. 2 illustrates an outer portion of the terminal assembly in accordance with some embodiments of the present disclosure.

FIG. 3A is a perspective view of an inner portion in accordance with some embodiments of the present disclosure.

FIG. 3B is a side view of the inner portion shown in FIG. 3A.

FIG. 4 is a cut-away view of the switching terminal assembly shown in FIG. 1 in accordance with the present disclosure.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

### Overview

In circuit breakers, interrupter gaps are closed off by terminal plates or a switching terminal having a plurality of protruding terminal pads. These protruding pads have a contact face with connection features to which cables and other electrical components can connect. In conventional high-voltage switching terminals, the terminal or contact pads are specifically designed to work with certain switching equipment. For example, the contact face locations and alignment requirements can vary based on the switching equipment in which the circuit breaker is installed. The shape, size, arrangement, and cable requirements of a switching equipment can also vary, which tend to dictate the shape, size, and contact pads arrangement of the switching terminal.

As a result, conventional switching terminals tend to each be specifically designed and fabricated for a specific type of switching equipment. In practice, as an example, when coupling cables or other components (e.g., bus interface) to the terminal pads, the user may need to physically manipulate the cable and/or the terminal pads in order to properly connect the terminal pad to the bus interface. For example, when installing the conventional switching terminal, the user may need to bend, flex, and distort the connection cable. If this is not possible, the angle in which the connection bus interfaces with the circuit breaker can be manipulated and perhaps a proper connection can be made. With conventional switching terminal, the above task is very hard to achieve. This is because current switching terminals are non-rotatable. In other words, the location and/or arrangement of the terminal pads cannot be changed as it is fabricated with specific pads location and arrangement. To compensate for the rigid and inflexible design of conventional switching terminals, users have used multiple stranded flexible cable to make the connection possible.

The switching terminal of the present disclosure is designed to provide maximum installation flexibility by providing rotatable terminal pads while using minimal parts. The contact or terminal pads of the disclosed switching terminal can be rotated at any angle and at any arbitrary location. This enables the terminal pads to be placed in an unlimited number of positions. An additional advantage of the disclosed switching terminal is that in example embodiments it has two main components as discussed below. In this way, the switching terminal is easy to assemble in the field and very easy to use.

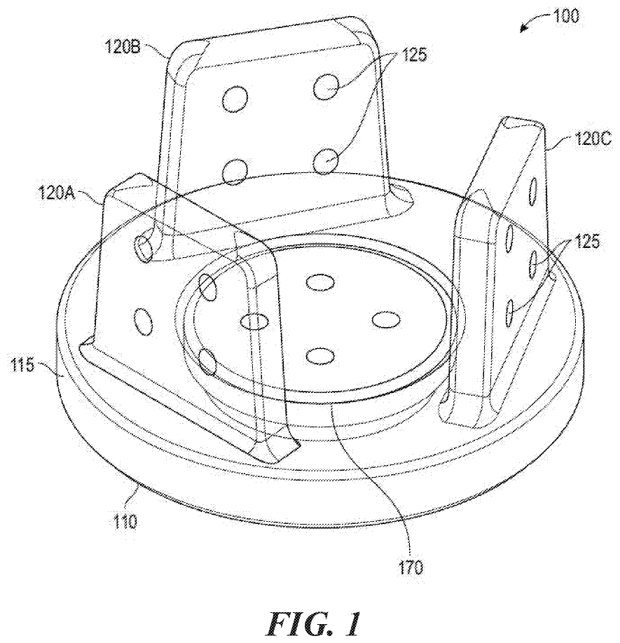

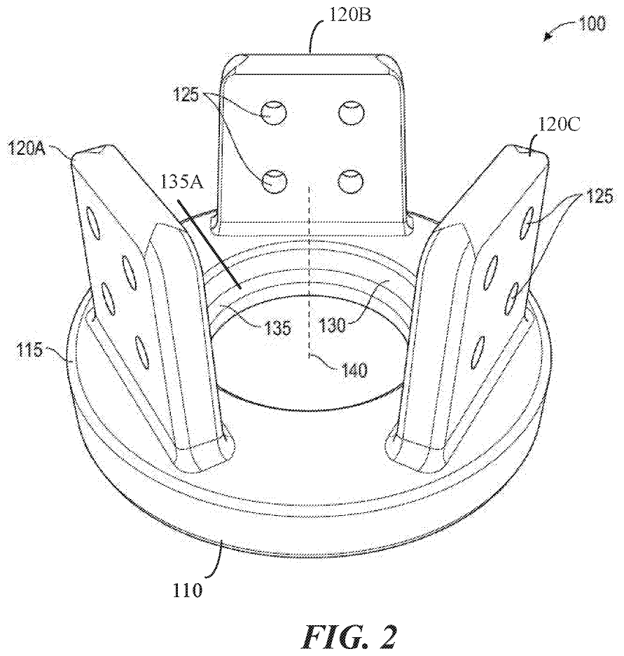

FIG. 1 is a perspective view of a terminal assembly 100 in accordance with some embodiments of the present disclosure. Terminal assembly 100 includes an outer or peripheral portion 110 and an inner portion 170 positioned in a recess 130 (see FIG. 2) of outer portion 110. Outer portion 110 can include one or more fins 120A, 120B, 120C that extend out of the main plane of outer portion 110. In some embodiments, outer portion 110 includes two or more fins. For example, outer portion 110 can have three fins. In another example, outer portion can have four or five fins. Each fin 120A, 120B, 120C can be substantially perpendicular to the main plane or surface 111 of outer portion 110. In some embodiments, each fin 120A, 120B, 120C can extend out at an angle ranging from ±15° degrees from the perpendicular plane that is perpendicular to the main plane 111 of outer portion 110.

Outer portion 110 can be formed from a single piece of material or can be formed using a plurality of separate components. For example, outer portion 110 can be a 3D-printed component, which can be printed as a single integrated piece. Outer portion 110 can also be formed using a plurality of separate components. For example, outer portion 110 can include a base portion or main body 115, a first fin 120A, a second fin 120B, and a third fin 120C. Each of the first, second, and third fins 120A, 120B, 120C can be attached to main body 115 using various attachment means such welding, fasteners (e.g., bolts), or industrial-strength adhesive (e.g., aerospace adhesive). In some embodiments, each of the fins 120A, 120B, 120C can be welded to main body 115.

The plurality of fins 120A, 120B, 120C can be arranged on outer portion 110 such that there is equal spacing between the fins 120A, 120B, 120C. For example, outer portion 110 can be a circle and can have three fins 120A, 120B, 120C. In this embodiment, the fins 120A, 120B, 120C are spaced apart by 120° degrees. In this way, the three fins 120A, 120B, 120C are equally spaced along the perimeter of outer portion 110. In another example, outer portion 110 can have four fins. In this embodiment, the fins are spaced apart by 90° degrees. In some embodiments, the spacing between the fins can be non-uniform or irregular.

Each fin 120A, 120B, 120C can have one or more holes 125, which can be made to conform with the NEMA (National Electrical Manufacturers Association) CC1 standard. In some embodiments, each fin 120A, 120B, 120C can have four holes 125 configure to receive fasteners such as, but not limited to, hex bolts, carriage bolts, socket screws, or other suitable types of bolt.

One or more holes 125 can have any number of holes and arrangement (e.g., physical layout) such that they are in compliance with other suitable standards such as, but not limited to, IEC (International Electrotechnical Commission), IEEE (Institute of Electrical and Electronics Engineers), etc.

Each of the fins 120A, 120B, 120C of outer portion 110 can have a rectangular shape. For example, each fin 120A, 120B, 120C can be a square or a rectangle. Each fin 120A, 120B, 120C can also have a trapezoidal shape. In some embodiments, each fin 120A, 120B, 120C can have a circular shape such as a semi-circle. Each fin 120A, 120B, 120C can also be non-conducting such as for example, but not limited to, a cooling fin. In some embodiments, outer portion 110 can have a combination of conductive and non-conductive (e.g., cooling) fins. For example, outer portion 110 can have a 3 conductive fins (one for each phase) and one or more cooling fins.

As previously mentioned, outer portion 110 can be formed from a single integrated piece of material. For example, outer portion can be formed using a milling printing process. Alternatively, the plurality of fins 120A, 120B, 120C can be separate components that can be attached to main body 115 of outer portion 110 using one or more fasteners (not shown). Each fin 120A, 120B, 120C can include one or more holes for fasteners to be inserted into to secure each fin 120A, 120B, 120C to the top of main body 115. Alternatively, fasteners can be inserted from the bottom of main body 115 of outer portion 110 and up into each fin 120A, 120B, 120C. The fasteners, whether inserted from the top or from the bottom of outer portion 110, can be located such that they do not interfere with the one or more holes 125 (e.g., NEMA CC1 holes) extending through each fin 120A, 120B, 120C.

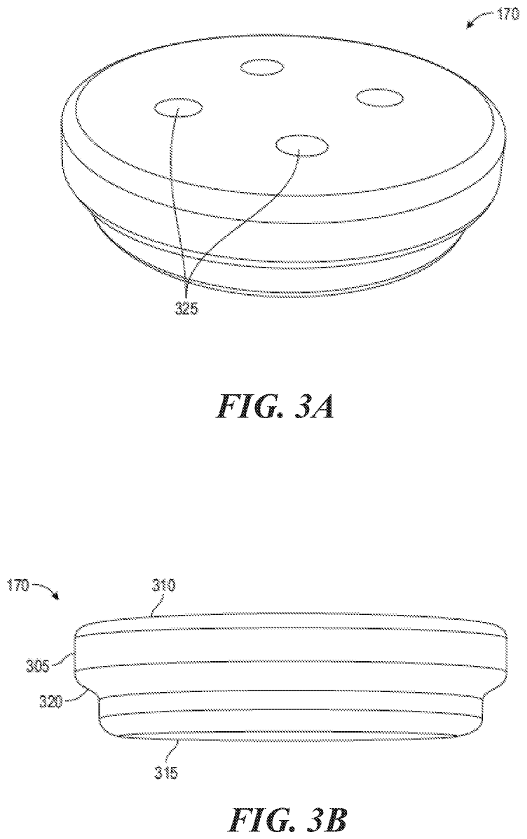

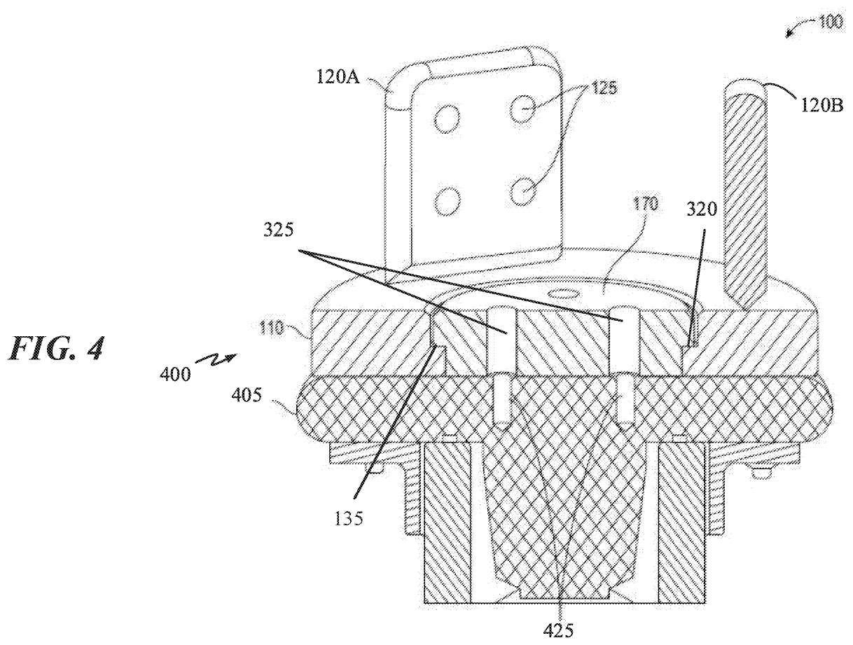

FIG. 2 is a perspective view of outer portion 110 of a terminal assembly 100 in accordance with some embodiments of the present disclosure. Outer portion 110 includes main body 115, recess area 130, and rim or lip 135. Main body 115 can have one or more fins 120A, 120B, 120C (or protruding pads) extending substantially perpendicular from main body 115. In some embodiments, main body 115 can have three fins 120A, 120B, 120C each spaced 120° degrees apart. Recess area 130 and inner portion 170 (see FIG. 3A and FIG. 3B) can have the same shape or profile. For example, both can have a circular shape that enables outer portion 110 to be rotated about inner portion 170 when not tightly fastened or secured. Recess area 130 can have a lip 135 that is configured to support inner portion 170. Lip 135 is also for securing outer portion 110 to inner portion 170 when inner portion 170 is tightly fastened to a surface of an external conductor element (see, e.g., #, FIG. 4). For example, once inner portion 170 is tightly fastened to another body, inner portion 170 is tightly mated with and pressed down on lip 135. The downward force and friction between the bottom surface (not shown) of inner portion 170 and the upper surface 135A of lip 135 cause outer portion 110 to be tightly secured such that it cannot be moved in the axial direction (i.e., along axis 140) or rotated about axis 140.

However, when adjustments to the location of fins 120 need to be made, outer portion 110 can be rotated about axis 140 by loosening the fastening force between inner portion 170 and the external conductor element. For example, by loosening the bolts (not shown) that secure inner portion 170 to the external body (e.g., external conductor element), the friction force between inner portion 170 and outer portion 110 is considerably lessened to allow outer portion 110 to be rotated about axis 140. Once inner portion 170 is loosely secured to the external body (not shown), the friction force between inner portion 170 and lip 135 is lessened such that outer portion 110 can be freely rotated about axis 140. However, outer portion 110 is still secured along the axial direction because inner portion 170 is still attached to the external conductor element—even when loosely attached.

Main body 115 of outer portion 110 can have a circular shape. Main body 115 can have other shapes such as, but not limited to, a polygonal shape (e.g., rectangular, hexagon), a triangular shape, or other irregular shapes. In some embodiments, main body 115 can be a polygon with the number of sides equal to the number of fins. For example, main body 115 can be a hexagon with 6 fins—one fin per side.

Outer portion 110 and inner portion 170 can be made with conductive metal or metal alloy. In some embodiments, outer portion 110 and inner portion 170 are fabricated from aluminum.

FIG. 3A is a perspective view of inner or center attachment portion 170 in accordance with some embodiments of the present disclosure. FIG. 3B is a side view of inner portion 170 as depicted in FIG. 3A. Both FIGS. 3A and 3B will be discussed concurrently. Inner portion 170 can be fabricated to have the same shape and profile, and substantially the same size, as recess area 130 such that both components conform to or mate with each other. Inner portion 170 is configured to drop into recess area 130 and mate with top surface 135A of lip 135.

In some embodiments, inner portion 170 can have a shape similar to a hockey puck. In this embodiment, inner portion 170 can have a straight vertical edge 305 extending from top surface 310 to bottom surface 315. Once inner portion 170 is inserted into recess area 130, bottom surface 315 is configured to mate with top surface 135A of lip 135. In this way, inner portion 170 can be seated into recess area 130 without falling completely through recess area 130. In other words, lip 135 is configured to support inner portion 170 once top surface 135A of lip 134 is mated with bottom surface 315 of inner portion 170 (since inner portion 170 is without a rim).

Alternatively, inner portion 170 can be fabricated to have rim 320 along the circumference of inner portion 170. Rim 320 is configured to mate with lip 135 once inner portion 170 is inserted into recess area 130. In this embodiment, inner portion 170 is supported by lip 135. At the same time, outer portion 110 is secured in the axial direction because inner portion 170 would prevent any axial movement once installed and secured to the external conductor element.

As shown, inner portion 170 can include one or more attachment holes 325. In some embodiments, inner portion 170 can have 4 holes. One or more holes 325 can be arranged in a pattern that they comply with the NEMA CC1 standard. For example, one or more holes 325 can be arranged such that it can match with the hole pattern of a corresponding component having a NEMA pad. Additionally, one or more holes 325 can have any number of holes and lay out such that they are in compliance with standards such as, but not limited to, IEC and IEEE. In some embodiments, inner portion 170 can have only one center hole.

FIG. 4 is a cut-out view of terminal assembly being mounted on an external conductor element in accordance with some embodiments of the present disclosure. Assembly 400 includes terminal assembly 100 and external conductor element 405, which can be a conductive pad or surface of an electrical component such as a bus. As shown, lip 135 of outer portion 110 supports inner portion 170. When the two components (inner and outer portions) are mated, outer portion 110 is secured down by rim 320 of inner portion 170. Once the fasteners (not shown) are inserted into holes 325 of inner portion 170 and screwed into holes 425 of conductor element 405, inner portion 170 becomes immoveable relative to conductor element 405. This in turn causes outer portion 110 to be immobilized in the axial direction and, when tightly fastened, also rotationally immobilized. When inner portion 170 is tightly fastened to conductor element 405, the friction force between inner and outer portions would be very high and would inhibit outer portion 110 from moving in the axial direction and rotating.

In the field, to rotate fins 120A, 120B, 120C and facilitate the installation of the switching terminal 100, the fasteners (not shown) in holes 325 and 425 can be loosened but not removed. In the loosened state, inner portion 170 is still attached to conductor element 405, which in turn still loosely secures outer portion 110. However, when the fasteners are loosened but not removed, the friction force between the outer portion 110 and inner portion 170 would dramatically reduce and thereby allow outer portion 110 to rotate with respect to inner portion 170. In this way, outer portion 110 can be rotated into any desired position such that fins 120A, 120B, 120C can be suitably and easily connected to cables and/or another conducting terminal. Once fins 120A, 120B, 120C are coupled to the bus/cables, the fasteners can be tightened to tightly secure switching terminal assembly 100.

As previously mentioned, fins 120A, 120B, 120C can be a combination of cooling and conducive pads. Along with the rotatability of the terminal, the combination of cooling and conductive pad provide greater flexibility in installation options.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the following detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

1. A switching terminal comprising:
an inner portion configured to be securely or loosely attached to an external conductor element; and
an outer portion configured to be rotatably affixed to the inner portion when then inner portion is loosely attached to the external conductor and to be tightly affixed to the inner portion when then inner portion is tightly attached to the external conductor, and wherein the outer portion comprises a plurality of fins.

2. The switching terminal of claim 1, wherein the outer portion comprises a recess area having a lip configured to mate with a bottom surface of the inner portion.

3. The switching terminal of claim 2, wherein the inner portion comprise a rim configured to mate with the lip of the outer portion.

4. The switching terminal of claim 1, wherein the plurality of fins comprises three fins extending substantially perpendicular to the outer portion.

5. The switching terminal of claim 1, wherein the inner portion comprises one or more holes to receive one or more bolts to attach the inner portion to the external conductor.

6. The switching terminal of claim 3, wherein the one or more holes of the inner portion comprise four holes having a pattern in compliance with NEMA, IEC, or IEEE standard.

7. The switching terminal of claim 1, wherein the inner portion and the central receiving area are circular.

8. The switching terminal of claim 1, wherein each of the plurality of fins comprises a plurality of holes.

9. The switching terminal of claim 8, wherein the plurality of holes of each fin are arranged in accordance with NEMA, IEC, or IEEE standard.

10. The switching terminal of claim 1, wherein the inner and outer portions comprises a conducting metal.

11. An apparatus with rotatable pads for voltage switching, the apparatus comprising:
a center attachment portion configured to be selectively attached loosely or tightly to a conductive surface; and
a peripheral portion having a recess to receive the center attachment portion, wherein the peripheral portion is configured to be rotatably affixed to the center attachment portion when the center attachment portion is loosely attached to the conductive surface and to be tightly affixed to the attachment portion when the attachment portion is tightly attached to the conductive surface, wherein the peripheral portion comprises a plurality of protruding pads.

12. The apparatus of claim 11, wherein the recess comprises a lip configured to engage and support the center attachment portion.

13. The apparatus of claim 11, wherein the center portion comprise a lip configured to engage and support the peripheral portion.

14. The apparatus of claim 11, wherein the plurality of protruding pads comprises three protruding pads extending substantially perpendicular to the center attachment portion.

15. The apparatus of claim 11, wherein the center attachment portion comprises one or more holes to receive one or more bolts to attach the center attachment portion to the external conductor.

16. The apparatus of claim 11, wherein the one or more holes of the inner portion are arranged in accordance with NEMA, IEC, or IEEE standard.

17. The apparatus of claim 11, further comprising one or more cooling fins extending from the peripheral portion.

18. The apparatus of claim 11, wherein each of the plurality of protruding pads comprises a plurality of holes.

19. A voltage switching terminal comprising:
an inner portion configured to be securely or loosely attached to an external conductor element; and
an outer portion configured to be rotatably or securely affixed to the inner portion when then inner portion is loosely or securely attached to the external conductor, respectively wherein the outer portion comprises a plurality of fins.

20. The voltage switching terminal of claim 19, wherein the outer portion comprises a recess area having a lip configured to mate with a bottom surface of the inner portion.
